(19) United States
(12) Patent Application Publication
(10) Pub. No.: US 2008/0250050 A1
(43) Pub. Date: Oct. 9, 2008

(54) Method and system for developing a desired set of configuration profiles for an application program and storage medium for storing a set of computer instructions which effectuate the method

(76) Inventors: Martin J. Cracchiolo, Macomb, MI (US); William G. Noble, South Lyon, MI (US); Jason D. Roller, Canton, MI (US); Charles A. Sherrit, Milford, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/732,929

(22) Filed: Apr. 5, 2007

(51) Int. Cl. G06F 17/00

(52) U.S. Cl. 707/102; 707/E17.005

(57) ABSTRACT

A method and system for developing a desired set of configuration profiles for an application program and storage medium for storing a set of computer instructions which effectuate the method are provided. The method includes the steps of displaying graphical representations of possible profile management operations on a display of the system, and receiving commands from a user of the system to select graphical representations from the displayed graphical representations. The selected graphical representations correspond to desired profile management operations. The method also includes the step of automatically generating a desired set of configuration profiles which correspond to the selected graphical representations. The desired set of configuration profiles is useful in analyzing network application traffic.

### BACKGROUND OF THE INVENTION

1. Field of the Invention

This invention relates to methods and systems for developing a desired set of configuration profiles for an application program and storage media for storing sets of computer instructions which effectuate the methods.

2. Background Art

Various software products have components which allow users to view application-specific statistics across networks. For example, Network Vantage (NV) is a product of the assignee of this application that uses a component called Interactive Viewer(IV) to view application-specific statistics across large and small networks. IV addresses different needs to view network data in different ways by correlating and presenting network and application performance data. IV can compare session-level response times and traffic volumes of user-selected applications to acceptable base lines for troubleshooting performance problems.

Within the viewing context there is a multitude of configuration parameters to allow ad-hoc viewing geared toward user preference and troubleshooting requirements. The problem is that once configured for specific user preference or troubleshooting needs, to change the configuration means to lose previously defined parameters.

The previous solution was to manually copy configuration files and settings from the current viewing context and attempt to store them, change them to the requested or desired configuration, and then restore them for future use. To get this information from a customer for troubleshooting requirements is very cumbersome and introduced serious risk to PC stability as there are several configuration settings stored in the system registry. This solution had very serious limitations and could lead to strained customer relationships.

When working with customers with issues requiring this scenario the customer is usually very capable technically. However, it introduces the risk of system registry corruption and is somewhat bothersome to the user.

Finally, existing techniques for multiple viewing contexts, configuration and troubleshooting solutions, such as Network Vantage solutions, are cumbersome, risky and outdated. Customer relations are affected by the primitive technologies used to retrieve vital troubleshooting configurations and the methods provided to allow multiple viewing contexts.

The Hayes, Jr., U.S. Pat. No. 6,205,476, discloses a method of managing user configuration preferences for applications executing at a user station, wherein the method allows administrators to configure an end user application directly by running the end user application while posing as a user or as a user group. Additionally, by running user applications in the context of a user and user configuration, rather than an administrator's configuration, the administrator is able to see the same screens that a user sees thereby aiding the administrator in diagnosing user problems. In other words, the method allows an administrator on a server to run an application on a workstation under the context of a specific user. The profiles described are for a PC. U.S. Pat. Nos. 6,105,063 and 6,105,066 are also relevant.

The Hayes, Jr., U.S. Pat. No. 6,237,092, provides for a common repository and client profile management system, wherein multiple configuration information profiles for various users/groups may be managed by a system administrator to configure applications in the context of a user or a user group. The method and system allow an administrator to change an application profile while running without having to restart the application.

The Styles, U.S. Pat. No. 6,871,221, discloses a resource configuration management method and graphical user interface for allowing a network administrator to fill-in predefined templates, wherein the method provides for executing application programs to validate configuration settings and run-time environmental variables, before applying configuration settings.

The Raymond, U.S. Pat. No. 7,010,593, discloses a troubleshooting mentor system for a distributed network system, wherein context-sensitive diagnostic data, troubleshooting instructions and a database of executable troubleshooting (TS) profiles may be utilized or managed by an administrator to assist customers in troubleshooting customer-incurred problem events.

The U.S. patent application publication to Velupillai, 2007/0022418 A1, discloses a method and system for managing configuration profiles related to a plurality of deployed network elements, wherein a tool may be configured to automatically analyze the stored configuration files based on any number of algorithms associated with desired settings and features for the configuration profiles. The analyzing step may be utilized to determine whether the configuration profile corresponds to required operation settings and to troubleshoot the profiles if errors are found therein.

### SUMMARY OF THE INVENTION

An object of the present invention is to provide a method and system for developing a desired set of configuration profiles for an application program and storage medium for storing a set of computer instructions which effectuate the method wherein at least some of the above-noted problems associated with the prior art are solved in a stable and user-friendly fashion.

In carrying out the above object and other objects of the present invention, a method for developing a desired set of configuration profiles for an application program using a computer system is provided. The method includes the steps of displaying graphical representations of possible profile management operations on a display of the system, and receiving commands from a user of the system to select graphical representations from the displayed graphical representations. The selected graphical representations correspond to desired profile management operations. The method further includes the step of automatically generating a desired set of configuration profiles which correspond to the selected graphical representations. The desired set of configuration profiles are useful in analyzing network application traffic.

The possible profile management operations may include creating a new profile, copying a profile and deleting a profile.

The possible profile management operations may include importing a profile from a previously configured environment.

The possible profile management operations may include exporting a profile.

The possible profile management operations may include changing profile location.

Each of the profiles may have configuration settings and the method may further include modifying the configuration settings of at least one of the profiles.

The desired set of configuration profiles may be capable of creating different perspectives of the same data.

Further in carrying out the above object and other objects of the present invention, a system for developing a desired set of configuration profiles for an application program is provided. The system includes a display, means for displaying graphical representations of possible profile management operations on the display, and means for receiving commands from a user of the system to select graphical representations from the displayed graphical representations. The selected graphical representations correspond to desired profile management operations. The system further includes means for automatically generating the desired set of configuration profiles which correspond to the selected graphical representations. The desired set of configuration profiles is useful in analyzing network application traffic.

The possible profile management operations may include creating a new profile, copying a profile and deleting a profile.

The possible profile management operations may include importing a profile from a previously configured environment.

The possible profile management operations may include exporting a profile.

The possible profile management operations may include changing profile location.

Each of the profiles may have configuration settings and the system may further include means for modifying the configuration settings of at least one of the profiles.

The desired set of configuration profiles may be capable of creating different perspectives of the same data.

Still further in carrying out the above object and other objects of the present invention, a computer readable storage medium that stores a set of software instructions which, when executed, develops a desired set of configuration profiles for an application program is provided. The set of software instructions includes instructions for displaying graphical representations of possible profile management operations on a display of a system, and instructions for receiving commands from a user of the system to select graphical representations from the displayed graphical representations. The selected graphical representations correspond to desired profile management operations. The set of software instructions also include instructions for automatically generating a desired set of configuration profiles which correspond to the selected graphical representations. The desired set of configuration profiles is useful in analyzing network application traffic.

The possible profile management operations may include creating a new profile, copying a profile and deleting a profile.

The possible profile management operations may include importing a profile from a previously configured environment.

The possible profile management operations may include exporting a profile.

The possible profile management operations may include changing profile location.

Each of the profiles may have configuration settings and the set of software instructions may further include instructions for modifying the configuration settings of at least one of the profiles.

The desired set of configuration profiles may be capable of creating different perspectives of the same data.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a screen shot which contains graphical representations of possible profile management operations on a display of a computer system and which is capable of receiving user commands to select one or more of the displayed graphical representations;

FIG. 2 is a screen shot which illustrates an import profile management operation;

FIG. 3 is a screen shot which illustrates an export profile management operation;

FIG. 4 is a screen shot which illustrates a change or changing profile location management operation;

FIG. 5 are schematic flow diagrams which illustrate how different profiles can display different perspectives of the same data;

FIG. 6 is a flow chart which illustrates profiles and data collection; and

FIG. 7 is a screen shot which illustrates a create new profile management operation.

### DETAILED DESCRIPTION OF THE PREFERRED EMBODIMENT(S)

In general, the invention includes a method and system for developing a desired set of configuration profiles for an application program and storage medium for storing a set of computer instructions which effectuate the method. One embodiment of the invention includes a computer program that is called from the original process(es) (i.e., program) to manage (i.e., add, delete, copy . . . ) configuration profiles that are used in a program product called Network Vantage (NV) for multiple viewing context. The program is integrated to the original program (i.e., NV) to modify and use the configuration settings pertaining to each profile, allowing users to take advantage of the ability to view the same or different sets of data with a different set of configurations.

The computer program in accordance with one embodiment of the invention is referred to herein as the “Profile Manager” (i.e., PM). A primary purpose of the PM is to manage or develop a set of desired profiles that will be used for the different NV analysis sessions. The managing or developing function may include creating new, copying from current profiles or deleting profiles no longer needed or desired. This gives the user the ability to standardize a set of profiles and build additional profiles using the standard profiles as a starting point.

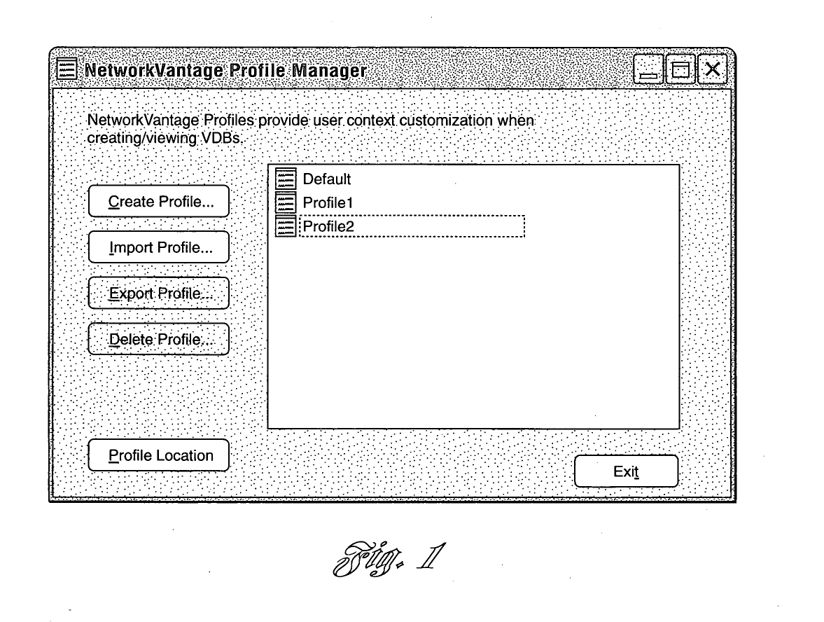

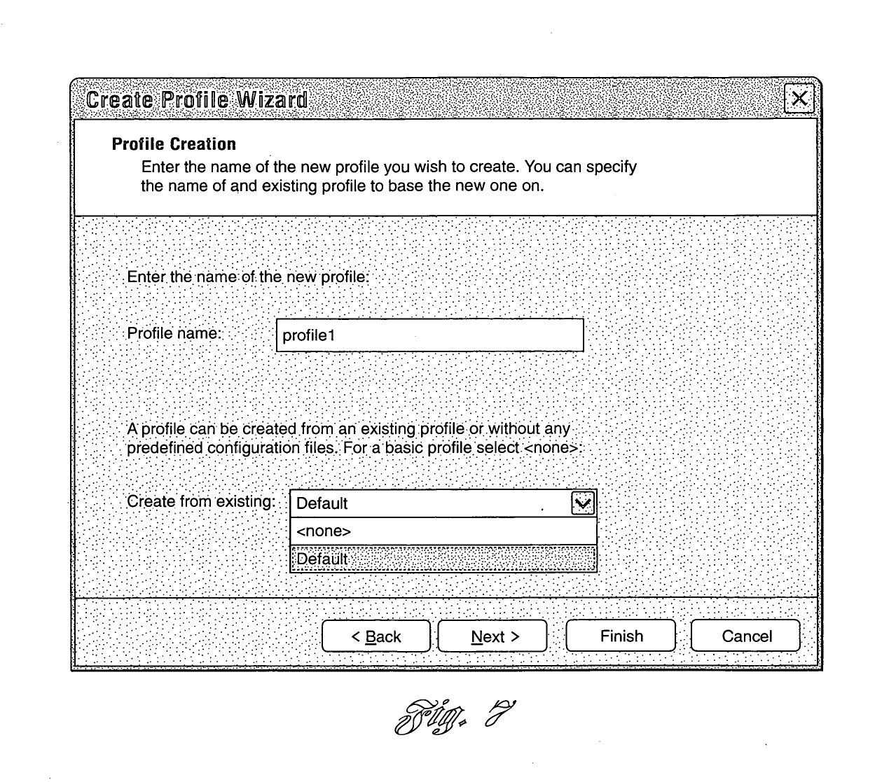

Referring now to the drawing figures, FIG. 1 is a screen shot which illustrates graphical representations of possible profile management operations on a display of a computer system and which is capable of receiving user commands to select one or more of the displayed graphical representations. FIG. 7 is a screen shot which illustrates a create new profile management operation.

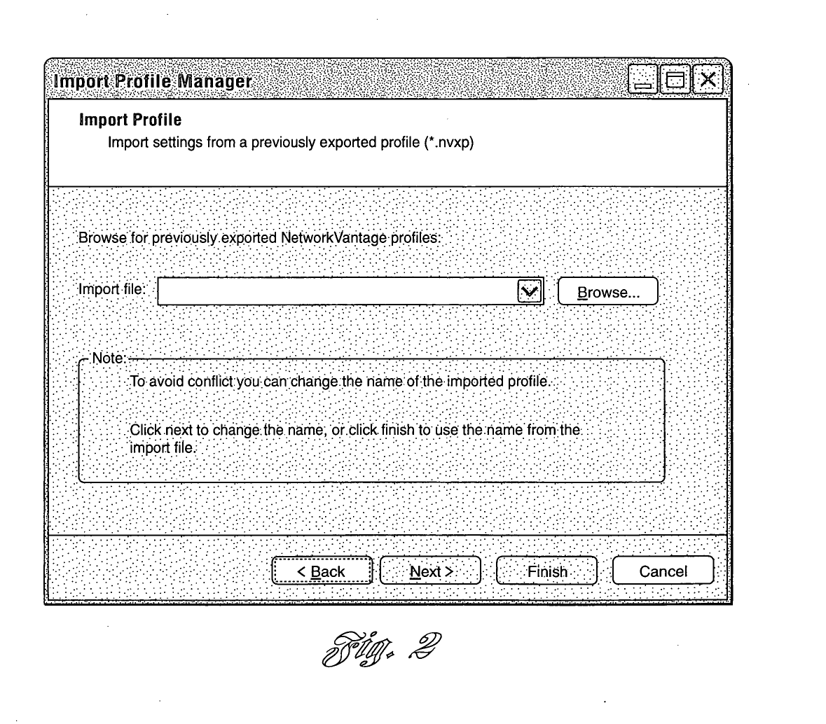

The Profile Manager (PM) program also performs three additional functions or tasks. First, the import functionality allows the user to import profiles from another NV environment that was previously configured. FIG. 2 is screen shot which illustrates an import profile management operation.

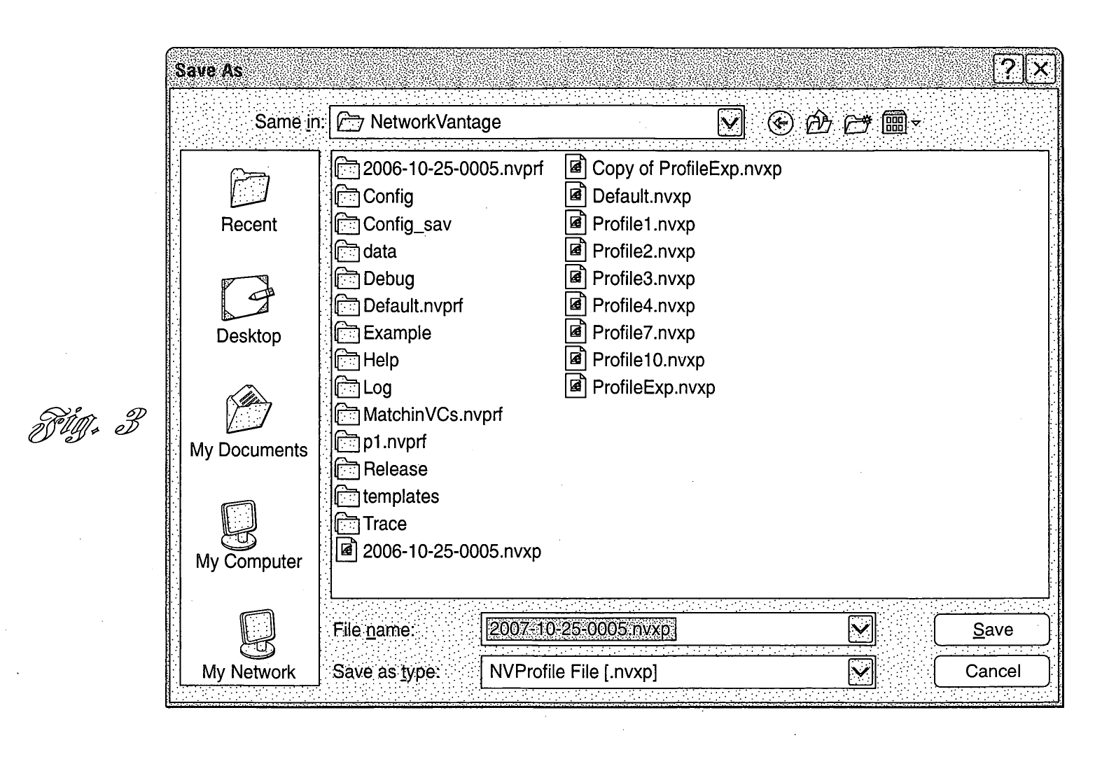

Second, the user can export specific profiles for use at alternate NV locations or to send to customer support to assist in problem resolution. FIG. 3 is a screen shot which illustrates an export profile management operation. This is very easy to perform and is very helpful for large customers that are running NV at multiple remote sites. Additionally, it assists customer support in simplifying the process of collecting user information for fast resolution of customer issues.

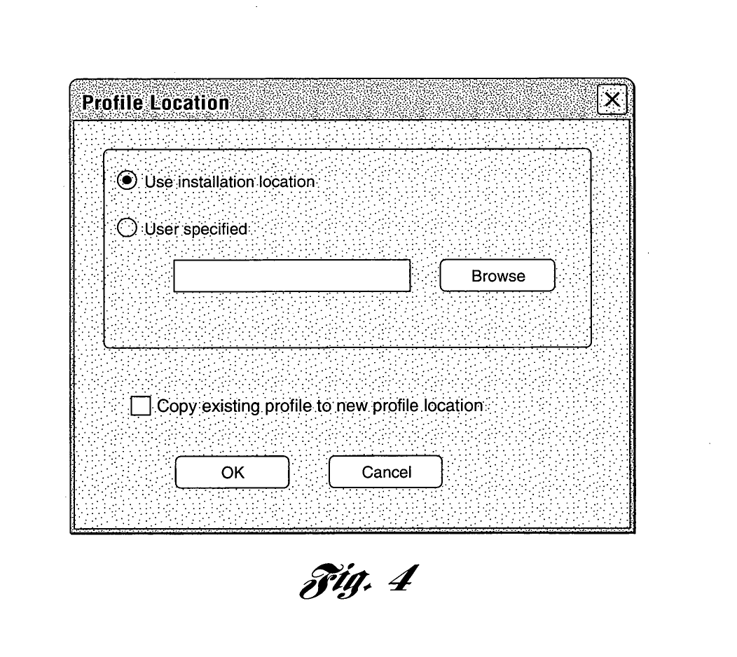

The third function is the ability to change the profile location and copy all existing profiles to that location for moving or sharing profiles among multiple users. FIG. 4 is a screen shot which illustrates a changing or change profile management operation.

The PM can be run standalone or from either of NV's interactive user applications (i.e., Interactive Viewer, Probe Manager . . . ).

Another process performed in accordance with an embodiment of the present invention is a configuration process. This process uses NV to manipulate an active profile and stores the information in both the registry and configuration files located on disk. These profiles can then be used for scheduled merges and network troubleshooting.

Within the viewing context of a visual database the user can configure screens, reports, and workspaces to allow for future troubleshooting in multiple environments. Different management level reporting can be provided to multiple locations based on business needs. Locking on different viewing criteria, renaming device objects, setting up Business Location and User Defined Links are all configured within the context of a profile and can be replicated as many times as needed to serve the client's business needs.

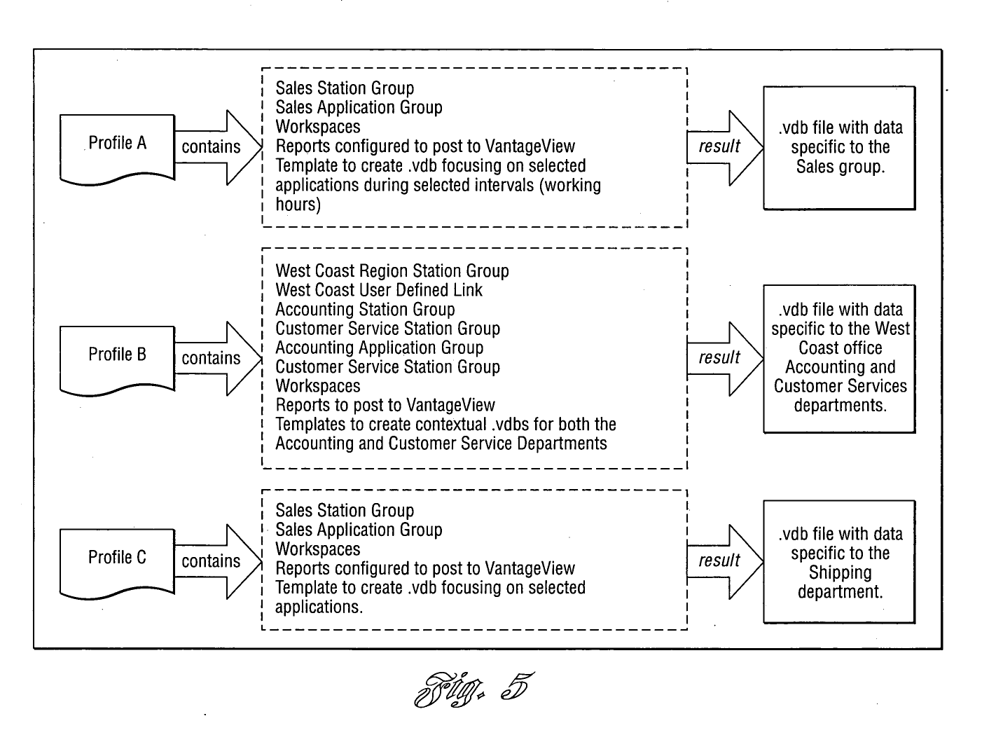

The above-described embodiment of the present invention provides significant benefits to users including users of Network Vantage. Profiles are an optional feature in Interactive Viewer of NV and allows one to store multiple sets of configuration options in order to create data with different perspectives, and allow multiple local users to store unique settings to produce contextual and pertinent data, while accessing the same installation of Interactive Viewer. FIG. 5 are schematic flow diagrams which illustrate how different profiles display different contexts of the same data.

By configuring profiles in the Probe Manager's probe group configuration, a user can generate multiple VDBs with either all or a subset of the collection's PDBs.

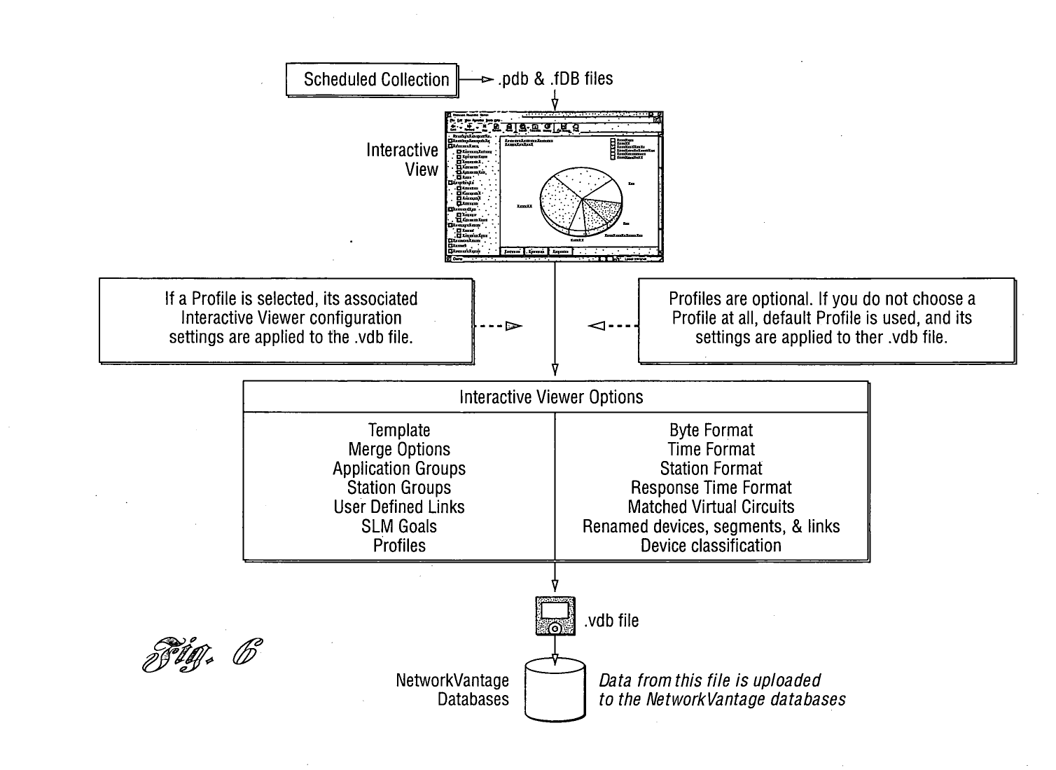

FIG. 6 is a flow chart which illustrates profile and data collection. Since the collected data, in the form of .pdb and .fdb files, can be remerged repeatedly, it is possible to create multiple .vdb files of the same collection, each with its own purpose. For instance, profiles can be used to easily:
Create multiple perspectives of the same data, from summarized, high-level data to detailed data for troubleshooting.
Easily monitor a network location or group of users.
Troubleshoot a problem area on the network.
Monitor specific applications.
Monitor specific applications, devices, segments, and WAN links.
Support data center operations by providing client-specific data.
Test the impact of Merge Options or Templates.

Initially, when Interactive Viewer is installed, a default Profile is created with out of the box settings. If no other Profiles are created, the default Profile, and its associated settings, are used when .vdb filed are created.

An example profile for Interactive Viewer (IV) and/or other applications would be the following:

Workspace(s) configured in previous session(s)

Views opened within the respective workspace(s)

Column order within the opened views

Sort order of the data within the columns

Time format for day/time fields (i.e. military time, system time, show leading zeros . . . )

Byte format for traffic related data (i.e. bytes, kilobytes, megabytes . . . )

Chart parameters (i.e. number of slices or bars, chart colors . . . )

Printing, reporting and posting options (i.e. Default printer, report location, posting location . . . )

Recently opened files

Displaying/hiding data configuration

Customizable defaults

Saving/Storing options

Profiles are managed by the respective application's functionality, with no modification to the application. By changing and modifying different application settings, as a user would normally do, the profile is managed on the fly. The Profile Manager (PM) harnesses, compresses and stores the perspective settings for future use and/or distribution.

As a general example, Profile1 is as follows:

### Profile 1

Workspace1
View1
   data sorted by column1
   column1 width 1
   column2 width 2
   column3 width 2
View2
   data sorted by column6
   column1 width 3
   column4 width 2
   column5 width 2
   column6 width 2

Workspace2
View4
   data sorted by column3
   column3 width 4
   column1 width 3
   column4 width 3
View5
   data sorted by column6
   column2 width 5
   column4 width 1
   column6 width 1
   column8 width 1
Default Printer: Printer1
Default post location: c:\profile1
Time format: 24 hour clock
Byte format: Megabytes
Chart attributes:

Number of chart sections to show: 5

Chart colors: Use classic

Chart background: White

Profile2 is as follows:

### Profile2

Workspace3
View6
   data sorted by column6
   column6 width 1
   column7 width 2
   column8 width 2
View7
   data sorted by column6
   column1 width 6
   column3 width 4
   column5 width 6
   column7 width 1

Workspace4
View8
   data sorted by column3
   column3 width 4
   column1 width 3
   column4 width 3
View9
   data sorted by column6
   column2 width 5
   column4 width 1
   column6 width 1
   column8 width 1
Default Printer: Printer2
Default post location: c:\profile2
Time format: Use system clock
Byte format: Megabytes
Chart attributes:

Number of chart sections to show: 3

Chart colors: XP style

Chart background: Black

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for developing a desired set of configuration profiles for an application program using a computer system, the method comprising the steps of:
displaying graphical representations of possible profile management operations on a display of the system;
receiving commands from a user of the system to select graphical representations from the displayed graphical representations, the selected graphical representations corresponding to desired profile management operations; and
automatically generating a desired set of configuration profiles which correspond to the selected graphical representations, the desired set of configuration profiles being useful in analyzing network application traffic.

2. The method as claimed in claim 1, wherein the possible profile management operations include creating a new profile, copying a profile and deleting a profile.

3. The method as claimed in claim 2, wherein the possible profile management operations include importing a profile from a previously configured environment.

4. The method as claimed in claim 2, wherein the possible profile management operations include exporting a profile.

5. The method as claimed in claim 2, wherein the possible profile management operations include changing profile location.

6. The method as claimed in claim 1, wherein each of the profiles has configuration settings and wherein the method further comprises modifying the configuration settings of at least one of the profiles.

7. The method as claimed in claim 1, wherein the desired set of configuration profiles are capable of creating different perspectives of the same data.

8. A system for developing a desired set of configuration profiles for an application program, the system comprising:
a display;
means for displaying graphical representations of possible profile management operations on the display;
means for receiving commands from a user of the system to select graphical representations from the displayed graphical representations, the selected graphical representations corresponding to desired profile management operations; and
means for automatically generating the desired set of configuration profiles which correspond to the selected graphical representations, the desired set of configuration profiles being useful in analyzing network application traffic.

9. The system as claimed in claim 8, wherein the possible profile management operations include creating a new profile, copying a profile and deleting a profile.

10. The system as claimed in claim 9, wherein the possible profile management operations include importing a profile from a previously configured environment.

11. The system as claimed in claim 9, wherein the possible profile management operations include exporting a profile.

12. The system as claimed in claim 9, wherein the possible profile management operations include changing profile location.

13. The system as claimed in claim 8, wherein each of the profiles has configuration settings and wherein the system further comprises means for modifying the configuration settings of at least one of the profiles.

14. The system as claimed in claim 8, wherein the desired set of configuration profiles are capable of creating different perspectives of the same data.

15. A computer readable storage medium that stores a set of software instructions which, when executed, develops a desired set of configuration profiles for an application program, the set of software instructions comprising instructions for:
displaying graphical representations of possible profile management operations on a display of a system;
receiving commands from a user of the system to select graphical representations from the displayed graphical representations, the selected graphical representations corresponding to desired profile management operations; and
automatically generating a desired set of configuration profiles which correspond to the selected graphical representations, the desired set of configuration profiles being useful in analyzing network application traffic.

16. The storage medium as claimed in claim 15, wherein the possible profile management operations include creating a new profile, copying a profile and deleting a profile.

17. The storage medium as claimed in claim 16, wherein the possible profile management operations include importing a profile from a previously configured environment.

18. The storage medium as claimed in claim 16, wherein the possible profile management operations include exporting a profile.

19. The storage medium as claimed in claim 16, wherein the possible profile management operations include changing profile location.

20. The storage medium as claimed in claim 15, wherein each of the profiles has configuration settings and wherein the set of software instructions further comprises instructions for modifying the configuration settings of at least one of the profiles.

21. The storage medium as claimed in claim 15, wherein the desired set of configuration profiles are capable of creating different perspectives of the same data.
